(19) United States
(12) Patent Application Publication
(10) Pub. No.: US 2007/0242769 A1
(43) Pub. Date: Oct. 18, 2007

(54) Method, System and Apparatus for Implementing Soft Frequency Reuse in Wireless Communication system

(75) Inventor: Xuezhi Yang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/756,473

(22) Filed: May 31, 2007

Related U.S. Application Data
(63) Continuation of application No. PCT/CN05/02046, filed on Nov. 29, 2005.

(30) Foreign Application Priority Data
Dec. 1, 2004 (CN) 200410096809.5
Apr. 20, 2005 (CN) 200510067540.2

(51) Int. Cl. H04K 1/10

(52) U.S. Cl. 375/260

(57) ABSTRACT

The embodiments of the present invention disclose a method, system and apparatus for implementing soft frequency reuse in a wireless communication system, the method includes: selecting for a cell or sector at least one carrier as a primary carrier and at least one carrier as a secondary carrier, the primary carrier and the secondary carrier are different; setting a first transmit power threshold for the primary carrier; setting a second transmit power threshold for the secondary carrier; the primary carrier selected for the cell or sector and a primary carrier selected for another cell or sector adjacent to the cell or sector are non-overlapped, and the first transmit power threshold is higher than the second transmit power threshold. The method, system and apparatus may reduce inter-cell interference and fully utilize frequency resources.

### CROSS-REFERENCES TO RELATED APPLICATIONS

This is a continuation of International Application No. PCT/CN2005/002046, filed Nov. 29, 2005, which claims the benefit of Chinese Patent Application No. 200410096809.5, filed Dec. 1, 2004; and Chinese Patent Application No. 200510067540.2, filed Apr. 20, 2005.

### BACKGROUND OF THE INVENTION

1. Field of the Invention

The present invention relates to frequency reuse techniques, and particularly, to a method, a system and an apparatus for implementing soft frequency reuse in a wireless communication system.

2. Background of the Invention

The next generation mobile communication system needs to support multiple services such as voice, data, audio, video, image and so on, therefore, it is desirable for the next generation mobile communication system to support a higher data transmission rate, higher spectrum efficiency and better Quality of Service (QoS) guarantee mechanisms, and provide better mobility support and wireless network coverage, so as to provide users with communication services at all times and all places. The second generation mobile communication system uses the Time Division Multiple Access (TDMA) and the narrowband Code Division Multiple Access (CDMA) as dominate access techniques, e.g., the Global System for Mobile Communications (GSM) and the CDMA IS-95 mobile communications system. The third generation mobile communication system uses the wideband CDMA as dominate access techniques, e.g., the Universal Mobile Telecommunication System (UMTS) and the Wideband CDMA (WCDMA) mobile communication system. In the CDMA technique, data symbols of one user will occupy the entire width of carrier frequency and different users or user data are distinguished by means of spread spectrum codes. Since the multi-path channel makes the orthogonality between spread spectrum codes impossible, the CDMA technique becomes a self-interference system. Therefore, the system capacity and spectrum efficiency of the current CDMA technique are unable to meet the requirements of wideband wireless communications.

Since the 1990's, a multi-carrier technique has been in the spotlight among wideband wireless communication techniques. It divides one wideband carrier into multiple sub-carriers on which data are transmitted in parallel. In most system applications, the width of a sub-carrier is less than the coherent bandwidth of the propagation channel. In this way, every sub-carrier demonstrates flat fading in a frequency-selective channel, which makes it possible to reduce inter-symbol interference and may support high-speed data transmission without complex channel equalization required. There are various multi-carrier techniques, for example, the Orthogonal Frequency Division Multiplexing (OFDM), the Multi-Carrier CDMA (MC-CDMA), the Multi-Carrier Direct Spread CDMA (MC-DS-CDMA), the Multi-Tone CDMA (MT-CDMA), the Multi-Carrier TDMA (MC-TDMA), the time-frequency two-dimension spreading technique and other spreading techniques based on the above mentioned techniques.

As a representative technique in multi-carrier techniques, the OFDM technique divides a given channel into multiple orthogonal sub-channels in the frequency domain and permits the overlap of partial frequency spectrum of sub-carriers. As long as the orthogonality between sub-carriers is guaranteed, data signals may be separated from the overlapping sub-carriers.

FIG. 1A is a simplified schematic diagram illustrating a data transmission process in the OFDM technique. As shown in FIG. 1A, the user data are first performed a channel coding and interleaving process and then transformed into symbols through a modulation scheme, e.g., Binary Phase Shift Keying (BPSK) modulation, Quaternary Phase Shift Keying (QPSK) modulation or Quadrature Amplitude Modulation (QAM), finally the symbols are modulated onto radio frequency through OFDM process. In the OFDM process, the symbols are first performed serial-to-parallel conversion to be converted into several low rate data sub-streams, each of which occupies a sub-carrier. The data sub-streams are mapped on the sub-carriers through Inverse Discrete Fourier Transform (IDFT) or Inverse Fast Fourier Transformer (IFFT). Cyclic Prefix (CP) is adopted by the OFDM technique as protection interval, which largely reduces, or even eliminates inter-symbol interference and assures the orthogonality of channels so that the inter-channel interference is greatly reduced.

It can be seen from the fore-going description that the multi-carrier mapping is performed through IDFT or IFFT, the spectrums of the sub-carriers are overlapping and orthogonal to one another, and the inter-symbol interference is avoided by means of the cyclic prefix. In the OFDM technique, the out-band attenuation of sub-carrier spectrum may be increased by adding windows, and the cyclic prefix may not be used through certain technical means. The user data transmission in the multi-carrier technique is shown in FIG. 1C, in which the user data are modulated first, e.g., performed channel coding, interleaving, symbol modulation and time domain and/or frequency domain spread. After the serial-to-parallel conversion, the modulated user data are mapped on multiple orthogonal or non-orthogonal sub-carriers through certain technical means, eventually the user data are performed parallel-to-serial modulation onto radio frequency.

The OFDM technique was first invented in the middle of the 1960's. The OFDM technique, however, was not widely applied for a long time because the development of the OFDM technique was impeded by many difficulties. Firstly, in the OFDM technique, the orthogonality between sub-carriers is required. Although the orthogonality between sub-carriers may be implemented theoretically by means of Fast Fourier Transform (FFT), it is impossible in practical applications to provide a device implementing such complex real time Fourier transform through the technical measures of the day. Secondly, the requirements on the stability of a transmitter oscillator and a receiver oscillator as well as the linearity of a radio frequency power amplifier also prevent the OFDM technique from being applied in practical applications. Since the 1980's, the development of a large scale integrated circuit technique has solved the problem of implementing the FFT. Along with the development of the Data Signal Processor (DSP) technique, the OFDM technique has been turned from the theory into practical application.

The OFDM technique rapidly becomes a study focus due to its inherent strong resistance to delay spread and its high spectrum efficiency, and is adopted by multiple international specifications such as the European Digital Audio Broadcast (DAB), the European Digital Video Broadcast (DVB), the High Performance Local Area Network (HIPERLAN), the Institution of Electrical and Electronics Engineers (IEEE) 802.11 Wireless LAN (WLAN) and the IEEE802.16 wireless Metropolitan Area Network (MAN). The multi-carrier technique was discussed as a dominate access technique at the Radio Access Network (RAN) conference of 3rd Generation Partnership Project (3GPP) held in 2004.

In an OFDM system, as the sub-carriers are orthogonal to one another, the interference between terminals in the same cell is considered to be minimum. In the case of continuous coverage, two terminals taking the same sub-carrier will encounter co-channel interference. A frequency hopping technique may be used to eliminate co-channel interference. A method for achieving frequency hopping in the OFDM technique includes: dividing the frequency spectrum resource into time-frequency grids, and setting each physical channel to correspond to a time-frequency grid. In a cell, the time-frequency grids corresponding to different physical channels are orthogonal to one another, hence interference between different physical channels in the cell is avoided.

FIG. 2 shows a simplified diagram of the basic OFDM time-frequency pattern. As shown in FIG. 2, the time-frequency pattern is generated based on a COSTA sequence with the length of 15, and all other time-frequency patterns are obtained by rotating the basic time-frequency pattern in the frequency domain. In the OFDM transmission method provided by the 3GPP, when Parameter Set 2 is adopted, a Transmission Time Interval (TTI) includes 12 OFDM symbols, and two time-frequency patterns thereof are shown herein: TFP₀=[13 5 3 9 2 14 11 15 4 12 7 10], TFP₁=[14 6 4 10 3 15 12 1 5 13 8 11].

In different cells, the time-frequency pattern adopted in a TTI is rotated at a time offset. Each cell has a unique time offset and, similar to scramble codes in the Wideband Code Division Multiple Access (WCDMA) system, the time offset is revisable in each TTI, therefore even the time-frequency patterns of two cells are identical in a TTI, the patterns will deviate from each other in the next TTI so that the inter-cell interference is averaged and the frequency reuse factor may be 1.

In the frequency-hopping technique, if every terminal is provided ⅓ of the total sub-carriers and the terminals select sub-carriers at random, the probability of a terminal selecting a certain sub-carrier is ⅓, the probability of a certain sub-carrier not being selected by any terminal is (1−⅓)×(1−⅓)×(1−⅓)= 8/27; the probability of a certain sub-carrier being selected by one terminal is C₃¹×⅓×(1−⅓)×(1−⅓)= 12/27; the probability of a certain sub-carrier being selected by two terminal is C₃²×⅓×⅓×(1−⅓)= 6/27 and the probability of a certain sub-carrier being selected by three terminal is ⅓×⅓×⅓= 1/27. That means the probability of none co-channel interference is 12/27, the probability of co-channel interference is 1/27+ 6/27= 7/27 and the probability of resource idling is 8/27. Therefore in random frequency-hopping, different terminals are likely to select the same sub-carrier and cause co-channel interference, or some sub-carriers may idle without any data transmission, which results in resource waste; both situations are disadvantageous concerning effective resource utilization.

### SUMMARY OF THE INVENTION

The embodiments of the present invention provide a method, a system and an apparatus for implementing soft frequency reuse in a wireless communication system.

A method for implementing soft frequency reuse in a wireless communication system includes:

selecting for a cell or sector at least one carrier as a primary carrier and at least one carrier as a secondary carrier, the primary carrier and the secondary carrier are different;

setting a first transmit power threshold for the primary carrier;

setting a second transmit power threshold for the secondary carrier;

the primary carrier selected for the cell or sector and a primary carrier selected for another cell or sector adjacent to the cell or sector are non-overlapped, and the first transmit power threshold is higher than the second transmit power threshold.

An apparatus for implementing soft frequency reuse in a wireless communication system includes:

a serial-to-parallel converter, configured to converting a data entered in serial into multiple parallel data sub-streams and export the data sub-streams;

an inverse Fourier transformer, configured to perform inverse Fourier transform for the data sub-streams, and map the data sub-streams onto multiple carriers, respectively;

a parallel-to-serial converter, configured to convert the multiple carriers into one data stream and export the data stream;

an adjuster, configured to multiply the parallel data sub-streams exported by the serial-to-parallel converter by a power coefficient; the power coefficient is used for adjusting transmit power of each carrier is not higher than a transmit power threshold; and

a control device, configured to control the power coefficient is not higher than a threshold of the power coefficient.

A system for implementing soft frequency reuse in a wireless communication system includes:

a first unit, configured to select for a cell or sector at least one carrier as a primary carrier and at least one carrier as a secondary carrier, the primary carrier selected for the cell or sector and a primary carrier selected for another cell or sector adjacent to the cell or sector are non-overlapped; and

a second unit, configured to set a first transmit power threshold for the primary carrier and a second transmit power threshold for the secondary carrier, the first transmit power threshold is higher than the second transmit power threshold.

According to the method, the system and the apparatus provided by the embodiments of the present invention, at the border of the cell or sector, i.e., in an area away from the base station of the cell or sector, a frequency reuse scheme with the frequency reuse factor equal to 3 is used; in an inner zone of the cell or sector, i.e., in an area nearby the base station of the cell or sector, a frequency reuse scheme with the frequency reuse factor equal to 1 is used. Since transmit power is restricted in the inner zone of the cell or sector, an island coverage in which the frequency reuse factor equals to 1 is formed. Setting different frequency reuse factors for different areas of one cell or sector not only avoids interference between adjacent cells or sectors in the case of continuous coverage so as to raise the communication rate at the border of the cell or sector but also adequately uses precious communication resources so as to implement high rate communications. Therefore, the method provided by the embodiments of the present invention may be referred to as a method for implementing soft frequency reuse. The interference between cells or sectors may be eliminated by means of a controllable frequency reuse scheme provided by the embodiments of the present invention, which is favorable to implement resource management strategies and improve the stability of networks.

### BRIEF DESCRIPTION OF THE DRAWINGS

FIG. 1A is a simplified schematic diagram illustrating a user data transmission process in the OFDM technique.

FIG. 1B is a simplified schematic diagram illustrating a user data transmission process in the frequency/time spread technique.

FIG. 1C is a simplified schematic diagram illustrating a user data transmission process in the multi-carrier technique.

FIG. 2 shows a simplified diagram of the basic OFDM time-frequency pattern.

FIG. 3A is a simplified schematic diagram illustrating the frequency reuse pattern with a frequency reuse factor equal to 2.

FIG. 3B is a simplified schematic diagram illustrating the frequency reuse pattern with a frequency reuse factor equal to 3.

FIG. 3C is a simplified schematic diagram illustrating the frequency reuse pattern with a frequency reuse factor equal to 4.

FIG. 3D is a simplified schematic diagram illustrating the frequency reuse pattern with a frequency reuse factor equal to 5.

FIG. 3E is a simplified schematic diagram illustrating the frequency reuse pattern with a frequency reuse factor equal to 6.

FIG. 3F is a simplified schematic diagram illustrating the frequency reuse pattern with a frequency reuse factor equal to 7.

FIG. 4 is a simplified schematic diagram illustrating the networking in which sub-carrier reuse is employed.

FIG. 5A is a simplified curve diagram illustrating the trend that the Signal to Interference Ratio (SIR) at the border of a cell changes with the frequency reuse factor in a sub-carrier reuse scheme.

FIG. 5B is a simplified curve diagram illustrating the trend that the channel capacity at the border of a cell changes with the frequency reuse factor in a sub-carrier reuse scheme.

FIG. 6 is a simplified schematic diagram illustrating the networking using a soft frequency reuse scheme according to an embodiment of the present invention.

FIG. 7 is a simplified schematic diagram illustrating the channel capacity in a soft frequency reuse scheme according to an embodiment of the present invention.

FIG. 8 is a simplified schematic diagram illustrating an apparatus for implementing soft frequency reuse according to an embodiment of the present invention.

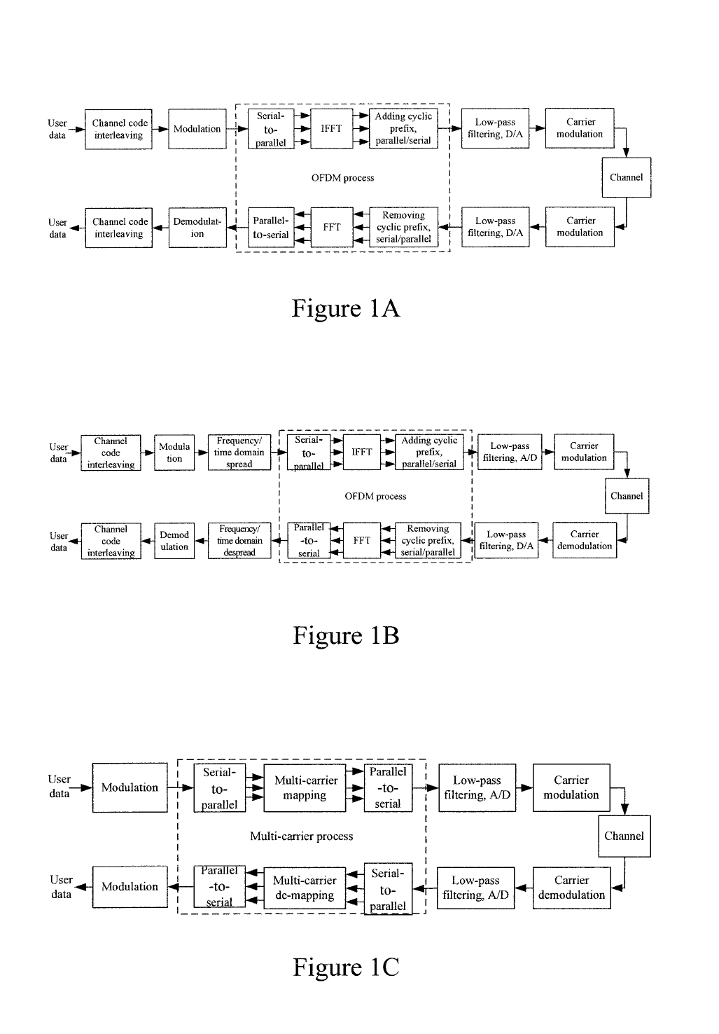

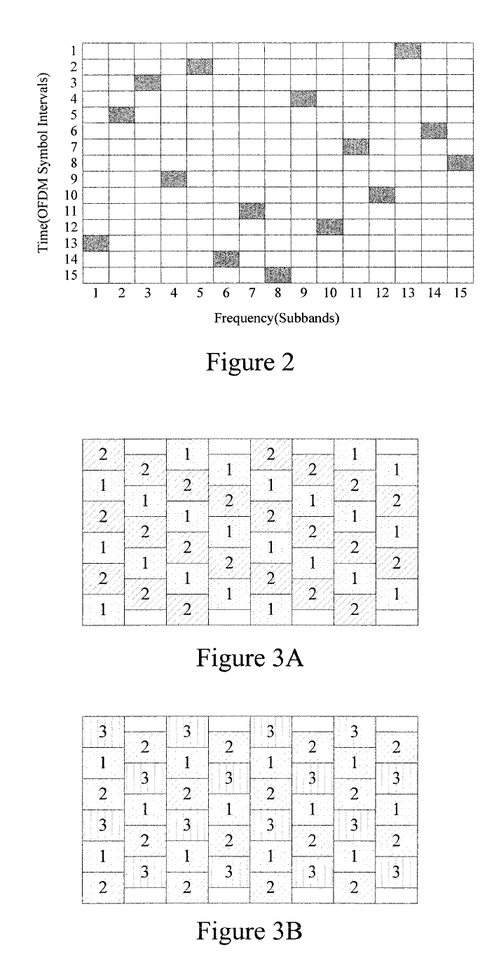

### DETAILED DESCRIPTION OF PREFERRED EMBODIMENTS

The embodiments of the present invention are further described in detail hereinafter with reference to the accompanying drawings.

In a random frequency hopping technique, on one hand, different terminals may select the same sub-carrier, which causes co-channel interference, and on the other hand, some sub-carriers may be idle without data transmission, which results in resource waste. However, when the frequency reuse factor is 3, ⅓ of the sub-carriers shall be allocated to every terminal and no co-channel interference shall thus emerge, as a result, all of the sub-carriers are utilized without collision. Therefore a technical scheme in which the frequency reuse factor is 3 is much more advantageous than the technical scheme which adopts the frequency hopping technique, i.e., in which the frequency reuse factor is 1.

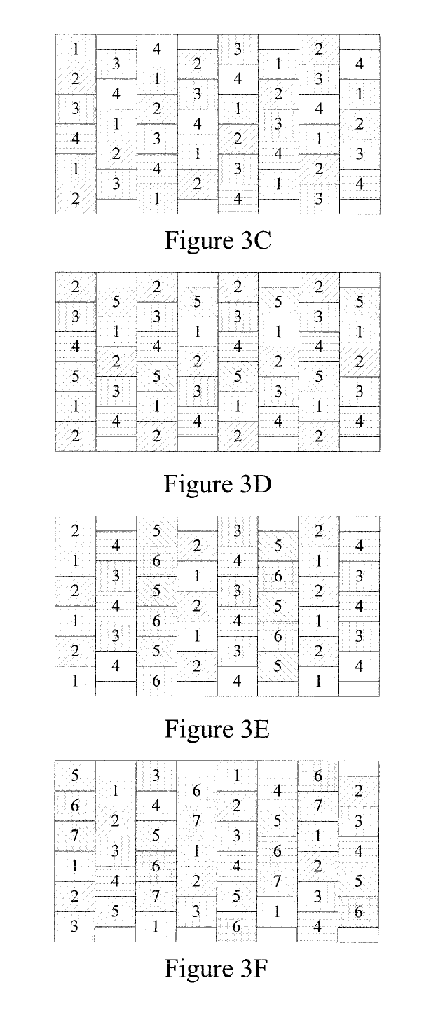

In 1947, the Bell Laboratories set forth the cellular concept. Owing to the propagation fading of radio waves, one carrier frequency may be reused beyond a certain distance. Thus, compared with the macro-cell networking technique, the cellular technique has higher spectrum efficiency. FIGS. 3A to 3F are simplified schematic diagrams illustrating frequency reuse pattern in which the frequency reuse factor ranges from 2 to 7.

In the first generation mobile communication system Frequency Division Multiple Access (FDMA) and the second generation mobile communication system TDMA, 7, 9 or 11 is usually selected as the frequency reuse factor to eliminate the co-channel interference. In the CDMA technique, the frequency reuse factor 1 is adopted, the same carrier frequency is used in all cells, and different scramble codes are set to distinguish one cell from another. In this way, complex frequency planning is not needed, and it is easy to implement soft switching and improve the spectrum efficiency. Therefore, the frequency reuse factor being set as 1 is regarded as a great advantage of the CDMA technique. Multi-carrier technique and the CDMA technique have different features, and the networking technique and frequency planning in the multi-carrier wireless communication system are highlighted by researchers at present.

In a cellular communication system, the Signal to Interference Ratio (SIR) of a receiver may be expressed as the following:

$$SIR = \frac{{P}_{rx}}{{P}_{intra \text{-} cell} + {P}_{inter \text{-} cell} + {P}_{n}} ,$$

in which Pᵣₓ represents the receive power of available signals, P_{intra-cell} represents the intra-cell interference power, P_{inter-cell} represents the inter-cell interference power and Pₙ represents thermal noise power.

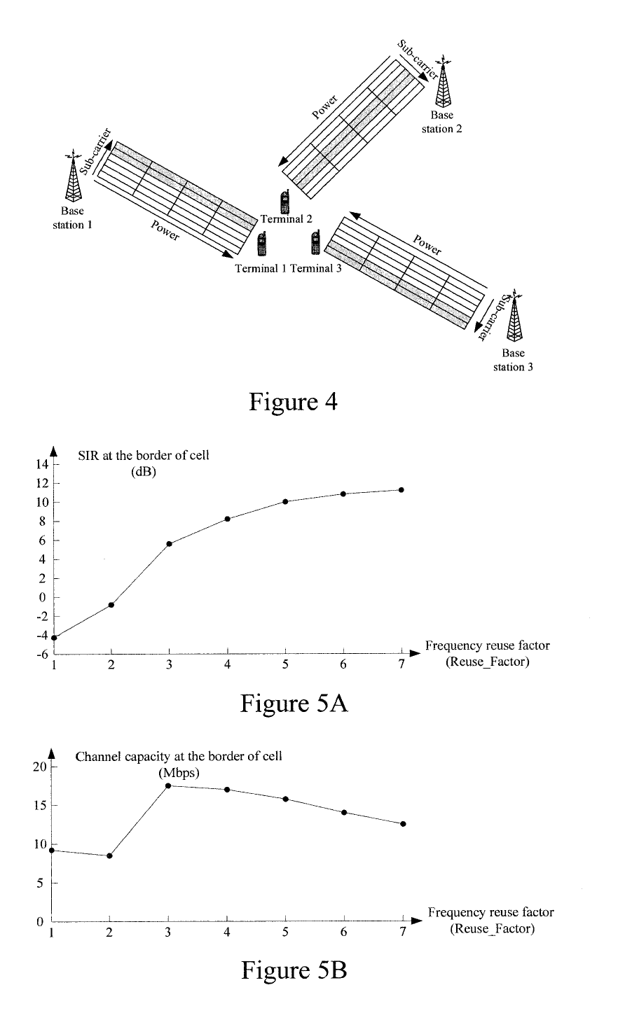

In the multi-carrier wireless communication system, frequency reuse may be achieved by implementing carrier frequency reuse and sub-carrier reuse. The carrier frequency reuse allows different carrier frequencies to be adopted by different cells, and each cell uses all of the sub-carriers. The sub-carrier reuse allows a carrier frequency to be adopted by different cells, and each cell uses different sub-carriers. Carrier-frequency reuse scheme is identical with conventional frequency reuse scheme in a single carrier system, in which a terminal needs to shift to another carrier frequency when the terminal switches to another cell, i.e., only hard switching is available. However, in the sub-carrier reuse scheme, different cells adopt the same carrier frequency with different sub-carriers, as shown in FIG. 4, therefore the terminal need not shift to another carrier frequency while switching to another cell and soft switching is thus achieved. In such way a cellular network may be constructed with only one carrier frequency, though the terminals in the cellular network are required to have higher broadband performance than those in carrier frequency reuse scheme.

If the carrier frequency width is W and the frequency reuse factor is reuse_factor in a multi-carrier wireless communication system, intra-cell multiple access interference may be eliminated by means of receive algorithms, i.e., P_{intra-cell} may be equal to 0 and every cell occupies 1/reuse_factor of the total carrier frequency width, to which the thermal noise decreases in proportion. As a result, the SIR of the receiver may be expressed as:

$$SIR = \frac{{P}_{rx}}{{P}_{inter \text{-} cell} + {P}_{n}} .$$

If the channel is a flat fading channel, the maximal error-free transmission rate in a cell, according to the Shannon channel capacity formula, may be expressed as the following:

$$C = \frac{W}{reuse\_factor} \cdot {log}_{2} ( 1 + SIR ) .$$

In different frequency planning schemes, if terminals are located at the cross point of three cells, as shown in FIG. 4, Radio Frequency (RF) parameters shown in Table 1 and the above formula may be used to obtain the trend that the SIR and the channel capacity at the border of cell change with the frequency reuse factor, and computing results are as shown in FIG. 5A and 5B.

TABLE 1

| RF parameter | value | Symbol |
|---|---|---|
| Carrier frequency width W (MHz) | 20 | A |
| Thermal noise density (dBm/Hz) | −174 | B |
| Noise Coefficient of receiver (db) | 5 | C |
| Thermal noise power Pₙ (dBm) | −96 | D = 10 * lgA + B + C |
| Transmit Power of base station (dBm) | 45 | E |
| Cell radius (Km) | 1 | F |
| Path loss (dB) | 137.3 | G = 137.3 + 35.2 * lg(F) |

FIG. 5A is a simplified curve diagram illustrating the trend that the Signal to Interference Ratio (SIR) at the border of a cell changes with the frequency reuse factor in a sub-carrier reuse scheme and FIG. 5B is a simplified curve diagram illustrating the trend that the channel capacity at the border of a cell changes with the frequency reuse factor in a sub-carrier reuse scheme. As shown in FIG. 5A and 5B, the channel capacity at the border of the cell in the case that the frequency reuse factor is equal to 1 are almost the same as that in the case that the frequency reuse factor is equal to 2. The channel capacity at the border of the cell is the maximum in the case that the frequency reuse factor is equal to 3, and then the channel capacity at the border of the cell gradually decreases along with the increase of the frequency reuse factor. It may be thus included that 3 is an ideal frequency reuse factor at the border of the cell. In addition, several problems need to be described in accordance with FIG. 5A and 5B.

1. The smaller the frequency reuse factor is, the wider the bandwidth available to each cell is, and the more serious the co-channel interference is, and the lower the SIR is; vice versa, the greater the frequency reuse factor is, the narrower the bandwidth available to each cell is, and the lighter the co-channel interference is, and the higher the SIR is.

2. When the frequency reuse factor is equal to 1 or 2, since co-frequency adjacent cells may exist, the co-channel interference will be serious and the SIR will be as low as −4.4 dB and −1.1 dB as shown in FIG. 5A, which results in smaller channel capacity at the border of the cell, i.e., channel capacity as low as 8 Mbps to 9 Mbps.

3. When the frequency reuse factor is 3, the interference of the co-frequency adjacent cells is eliminated, so the SIR increases significantly, e.g., the SIR is equal to 5.89 dB as shown in FIG. 5A. Although only ⅓ of total bandwidth is utilized at the border of the cell, the increase of the SIR may compensate the losses caused by the decreasing of bandwidth. As shown in FIG. 5B, the channel capacity increases by nearly 100% to 15 Mbps.

4. When the frequency reuse factor continuously increases, the co-channel interference continuously decreases and the SIR continuously increases. When the frequency reuse factor is equal to 7, the SIR reaches 11 dB. Since the channel capacity and the SIR comply with logarithmic relation, the increase of the channel capacity acquired through the increase of the SIR is unable to compensate the losses caused by the decreasing of bandwidth. Therefore, the channel capacity presents a descending trend as a whole.

5. In the formula

$$SIR = \frac{{P}_{rx}}{{P}_{inter \text{-} cell} + \frac{{P}_{n}}{reuse\_factor}} ,$$

the intra-cell multiple access interference is eliminated by means of receive algorithms or other measures, i.e., the receiver noise mainly includes the co-channel interference and the thermal noise. Since the intra-cell interference is a main noise component in the conventional CDMA communication system adopting RAKE receiver techniques, the most suitable frequency reuse scheme adopts 1 as the frequency reuse factor.

6. If the frequency reuse factor increases beyond 3, the channel capacity at the border of the cell just decreases a little and is still higher than the channel capacity in the case that the frequency reuse factor is equal to 1 or 2. However, when the frequency reuse factor reaches a large number, e.g., 7, the SIR of the receiver may reach 11 dB. Though the SIR increases because of the decrease of the co-channel interference, the receive power of the receiver does not increase, which means that the anti-interference capability of the receiver is poor. Such factors as the interference of environments around the receiver, the residual interference in the cell caused by demodulation algorithms or the adjacent channel interference noise will greatly reduce the SIR and the channel capacity. As a result, the channel capacity at the border of the cell presents a descending trend when the frequency reuse factor is greater than 3.

The channel capacity at the border of the cell is increased and the inter-cell interference is avoided by using the frequency reuse at the border of the cell. The border of the cell is an area with the severest interference in the cell, but the terminal may be located at the center of the cell and be near a base station in practical operations. If the terminal is close to the base station, the signal power from the cell is high and the interference from adjacent cells is low, which makes it possible to acquire a higher SIR. In this way, the frequency of adjacent cells may be used at the center of the cell, thereby implementing the high rate communications.

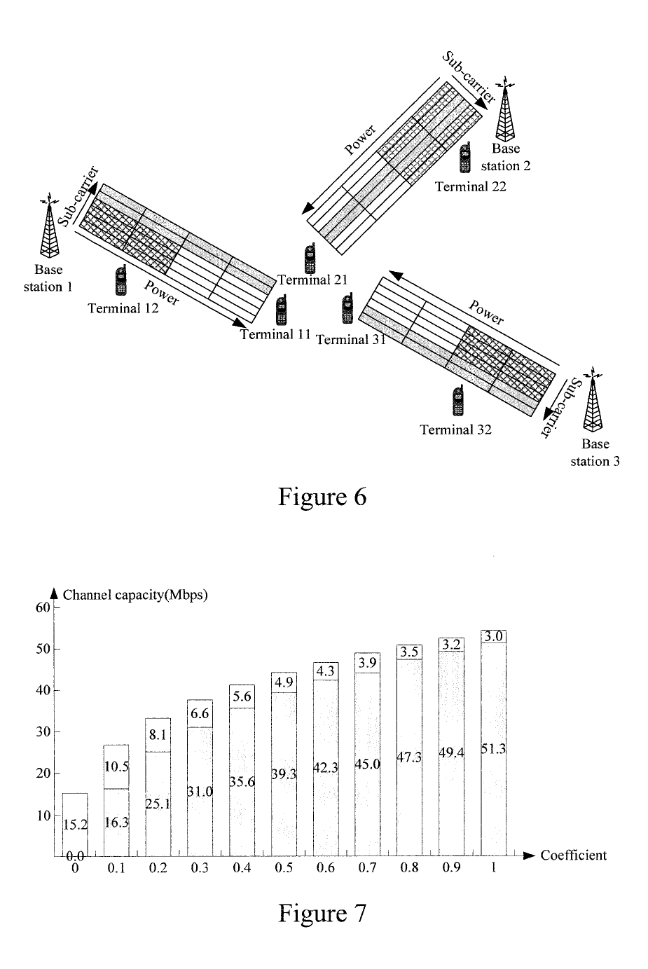

FIG. 6 is a simplified schematic diagram illustrating the networking using a soft frequency reuse scheme according to an embodiment of the present invention. In FIG. 6, Base station 1 manages Terminal 11 and Terminal 12, Terminal 12 is located in an inner zone of the area managed by Base station 1, for example, 30% of the radius of the cell taking Base station 1 as the center, and Terminal 11 is located at the border of the area managed by Base station 1, for example, 90% of the radius of the cell taking Base station 1 as the center. Base station 2 manages Terminal 21 and Terminal 22, Terminal 22 is located in an inner zone of the area managed by Base station 2, for example, 20% of the radius of the cell taking Base station 2 as the center, and Terminal 21 is located at the border of the area managed by Base station 2, for example, 85% of the radius of the cell taking Base station 2 as the center. Base station 3 manages Terminal 31 and Terminal 32, Terminal 32 is located in an inner zone of the area managed by Base station 3, for example, 50% of the radius of the cell taking Base station 3 as the center, and Terminal 31 is located at the border of the area managed by Base station 3, for example, 95% of the radius of the cell taking Base station 3 as the center. In an embodiment of the present invention, different sub-carriers of different frequencies are allocated to terminals at the border of the cell, which may avoid or reduce the co-channel interference, and improve the communication rate at the border of the cell. The terminal in the inner zone of the cell may reduce the interference with the adjacent cells by limiting the transmit power and utilize the bandwidth adequately to improve the communication rate.

As can be seen from the above description, according to the embodiments of the present invention, at the border of a cell, i.e., in the area away from the base station of the cell, a frequency reuse scheme with the frequency reuse factor equal to 3 is used, and in the inner zone of the cell, i.e., in the area near the base station of the cell, a frequency reuse scheme with the frequency reuse factor equal to 1 is used. Since the transmit power is restricted in the inner zone of the cell, island coverage in which the frequency reuse factor equals to 1 is formed. Setting different frequency reuse factors for different areas of one cell not only avoid the interference between adjacent cells in the case of continuous coverage so as to improve the communication rate at the border of the cell but also adequately utilize precious communication resources so as to implement high rate communications.

In the embodiments of the present invention, all sub-carriers are divided into N sub-carrier groups, and each cell selects one sub-carrier group as its primary sub-carrier and other sub-carrier groups as its secondary sub-carriers. Different transmit power thresholds are set for the primary sub-carrier and the secondary sub-carriers of each cell, and the transmit power corresponding to each sub-carrier is unable to exceed the transmit power threshold set for the sub-carrier. For example, the transmit power threshold of the primary sub-carrier is set as higher than the transmit power threshold of the secondary sub-carriers. The border of the cell is determined through the coverage area of the transmit power threshold of the primary sub-carrier. The terminal in the inner zone of the cell uses the secondary sub-carriers and the terminal at the border of the cell uses the primary sub-carrier. In this way, the interference at the borders of adjacent cells may be decreased greatly.

In addition, the divided sub-carrier groups and the selected primary sub-carrier and secondary sub-carriers may be fixed, or the sub-carrier groups and the primary sub-carrier and the secondary sub-carriers may change dynamically based on time as long as the same sub-carrier is not used synchronously at adjacent cells. For example, there are six sub-carriers identified as 1, 2, 3, 4, 5 and 6 respectively, sub-carriers identified as 1 and 2 are placed into one sub-carrier group, the sub-carriers identified as 3 and 5 are placed into one sub-carrier group, the sub-carrier identified as 4 is placed into one sub-carrier group and the sub-carrier identified as 6 is placed into one sub-carrier group. Cell 1 selects the sub-carrier group including the sub-carriers identified as 1 and 2 as its primary sub-carrier and other sub-carrier groups as its secondary sub-carriers, and the adjacent Cell 2 selects the sub-carrier group including the sub-carrier identified as 4 as its primary sub-carrier and other sub-carrier groups as its secondary sub-carriers. After a period of time, the six sub-carrier groups may be regrouped, the sub-carriers identified as 2 and 5 are placed into one sub-carrier group, the sub-carriers identified as 4 and 6 are placed into one sub-carrier group, the sub-carrier identified as 1 is placed into one sub-carrier group and the sub-carrier identified as 3 is placed into one sub-carrier group. Cell 1 selects the sub-carrier group including the sub-carriers identified as 4 and 6 as its primary sub-carrier and other sub-carrier groups as its secondary sub-carriers, and the adjacent Cell 2 selects the sub-carrier group including the sub-carrier identified as 3 as its primary sub-carrier and other sub-carrier groups as its secondary sub-carriers.

If macro problems like system capacity and spectrum efficiency are considered, the typical value of N is 3 to keep the system capacity and the spectrum efficiency both at the maximum. Other values are also be assigned to N, e.g., 4, 5, 6, 7 or 8, etc.

A full coverage type channel, such as a broadcast channel and public control channel, may be set to use the primary sub-carrier of the cell only and adopt comparatively higher transmit power. Although the coverage area of adjacent cells overlaps partially each other, the interference between adjacent cells is comparatively lower, which is favorable for terminals to select cell, handover and accurately receive public control information.

In the embodiments of the present invention, the primary sub-carrier may be used to bear signalings to guarantee the reliability of the signalings.

The service channel may be set to only use the primary sub-carrier when a terminal is located at the border of the cell. Since the primary sub-carriers of adjacent cells do not overlap each other, it is possible to reduce the interference between adjacent cells and improve the communication quality.

The primary sub-carrier and the secondary sub-carriers may be used simultaneously when the terminal is close to the base station, so as to transmit data and multimedia services at a high rate. Since the transmit power of the secondary sub-carriers are relatively lower, the interference with the adjacent cells is reduced and the spectrum efficiency is improved. The distance between the terminal and the base station may be predefined, e.g., 75% of the coverage area of the cell. If the distance is within the predefined distance, it is regarded that the terminal is close to the base station.

As shown in FIG. 6, if Terminal 11, 21 and 31 are located at the border of their respective cells, while Terminal 12, 22 and 32 are located in the inner zone of their respective cells, e.g., less than or equal to ½ radius of their respective cells taking base stations as center. The transmit power used by the terminals in the inner zone of the cell is less than that used by the terminals at the border of the cell. FIG. 7 is a simplified schematic diagram illustrating the channel capacity in a soft frequency reuse scheme according to an embodiment of the present invention. In FIG. 7, the coefficient shown by the horizontal axis is the ratio of the transmit power used by the terminals in the inner zone of the cell to that used by the terminals at the border of the cell. The gray blocks represent the channel capacity in the inner zone of the cell and the white blocks represent the channel capacity at the border of the cell. It can be seen from FIG. 7 that:

1. When the coefficient is equal to 0, the channel capacity is equivalent to the channel capacity at the border of the cell in the case that the frequency reuse factor is equal to 3, which is equal to 15.2 Mbps.

2. When the coefficient gradually increases, i.e., the transmit power used by the terminals in the inner zone of the cell gradually increases, the channel capacity in the inner zone of the cell gradually increases, the channel capacity at the border of the cell gradually decreases, and the channel throughput of the cell increases.

3. When the coefficient is up to 1, the channel capacity at the border of the cell decreases to 2.96 Mbps, just equal to ⅓ of channel capacity in the case that the frequency reuse factor is equal to 1, because only ⅓ of the total bandwidth is utilized at the border of the cell while the interference remains the same as the inference in the co-frequency reuse scheme.

It can thus be concluded that when the ratio between the transmit power thresholds of the secondary sub-carriers and the transmit power threshold of the primary sub-carrier moves from 0 to 1, the frequency reuse factor also moves smoothly from 3 to 1, so the method provided by the embodiments of the present invention may be called a soft frequency reuse scheme. The multi-carrier wireless communication system in which soft frequency reuse scheme is adopted may distribute power appropriately based on the network conditions, which, together with adaptive link techniques, leads to the most optimized system throughput and performance.

In the fore-going description, the inner zone of the cell may be the area whose center is the base station and radius is not greater than 50% of the radius of the cell, and the rest area of the cell may be taken as the border of the cell. The inner zone of the cell may also be the area whose center is the base station and radius is not greater than 60% of the radius of the cell, and the rest area of the cell may be taken as the border of the cell. The inner zone of the cell may also be the area whose center is the base station and radius is not greater than 35% of the radius of the cell, and the rest area of the cell may be taken as the border of the cell.

Furthermore, the ratio between the transmit power thresholds of the secondary sub-carriers and the transmit power threshold of the primary sub-carrier may be adjusted dynamically, e.g., when it is determined that the proportion between the traffic at the border of the cell and the total traffic of the cell or sector is increasing, the ratio between the transmit power thresholds of the secondary sub-carriers and the transmit power threshold of the primary sub-carrier shall be reduced; and when it is determined that the proportion between the traffic at the border of the cell and the total traffic of the cell or sector is decreasing, the ratio between the transmit power thresholds of the secondary sub-carriers and the transmit power threshold of the primary sub-carrier shall be increased. In such way the spectrum resource may be fully utilized.

It should be noted that, though the fore-going description explains embodiments in cells, the embodiments of the present invention are also applicable to sectors.

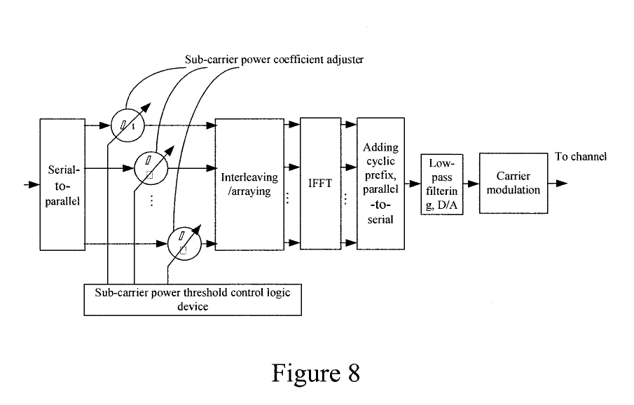

The embodiments of the present invention also provide an apparatus for implementing the soft frequency reuse scheme by making the transmit power of the sub-carrier controllable and adjustable and dividing all sub-carriers into the primary sub-carrier group and the secondary sub-carrier groups. As shown in FIG. 8, the apparatus includes:

a serial-to-parallel converter, for converting data entered in serial into multiple parallel data streams and exporting the parallel data streams;

a sub-carrier power coefficient adjuster, for multiplying the parallel data streams by a power coefficient before the parallel data streams are received by an inverse Fourier transformer, herein the power coefficient is used for adjusting the power of the sub-carriers on which the data streams are mapped;

a sub-carrier power threshold control logic device, for controlling the threshold of the power coefficient by which each sub-carrier is multiplied, and to be specific, for providing a threshold for the power coefficient of each sub-carrier and limiting the variation of the power coefficient thereby in the threshold to divide all sub-carriers into a primary sub-carrier group with high power and secondary sub-carrier groups with low power;

an inverse Fourier transformer, for receiving the parallel data streams, performing inverse Fourier transform and mapping the data streams on multiple corresponding sub-carriers;

a parallel-to-serial converter, for receiving the sub-carriers exported by the inverse Fourier transformer, converting the multiple sub-carriers into one data stream and exporting the data stream.

As shown in FIG. 8, the apparatus may further includes: an interleave/array unit, for arraying the data streams to be received by the inverse Fourier transformer in an interleaving manner, and a cyclic prefix adding unit, for adding a cyclic prefix into every sub-carrier to be converted by the parallel-to-serial converter.

The fore-going description is based on multi-carrier wireless communication system, however, the method provided by the embodiments of the present invention for implementing soft frequency reuse is also applicable to any wireless communication system, e.g., a simple carrier wireless communication system, in which a cell may adopt multiple frequencies, i.e., multiple carriers which may be divided into several carrier groups, and a carrier group may be set as the primary carrier group and the rest carrier groups may be set as the secondary carrier groups, thus soft frequency reuse is achieved. It should be further noted that each carrier group does not overlap one another.

The foregoing is only preferred embodiments of the present invention and is not for use in limiting the protection scope thereof.

What is claimed is:

1. A method for implementing soft frequency reuse in a wireless communication system, comprising:
selecting for a cell or sector at least one carrier as a primary carrier and at least one carrier as a secondary carrier, the primary carrier and the secondary carrier are different;
setting a first transmit power threshold for the primary carrier;
setting a second transmit power threshold for the secondary carrier;
the primary carrier selected for the cell or sector and a primary carrier selected for another cell or sector adjacent to the cell or sector are non-overlapped, and the first transmit power threshold is higher than the second transmit power threshold.

2. The method of claim 1, wherein the selecting at least one carrier as a primary carrier and at least one carrier as a secondary carrier comprises:
dividing carriers into at least one first group and at least one second group;
selecting a carrier in the at least one first group as the primary carrier; and
selecting a carrier in the at least one second group as the secondary carrier.

3. The method of claim 2, wherein the dividing carriers into at least one first group and at least one second group is implemented by one of the following ways:
dividing the carriers into the at least one first group and at least one second group dynamically;
dividing the carriers into the at least one first group and at least one second group in a static way.

4. The method of claim 2, wherein the carriers are divided into three groups, one of the three groups is selected as the primary carrier, and the other two groups are selected as the secondary carrier.

5. The method of claim 1, wherein the transmit power of the primary carrier is not higher than the first transmit power threshold set for the primary carrier; and
the transmit power of the secondary carrier is not higher than the second transmit power threshold set for the secondary carrier.

6. The method of claim 1, further comprising:
using the primary carrier in the cell or sector; and
using the secondary carrier in an inner zone of the cell or sector;
wherein the transmit power of one carrier used in the cell or sector is not higher than the first transmit power threshold when the primary carrier is used in the cell or sector, and the transmit power of one carrier used in the inner zone of the cell or sector is not higher than the second transmit power threshold when the secondary carrier in the inner zone of the cell or sector.

7. The method of claim 6, wherein the inner zone of the cell or sector is an area of which radius is 20%, 30% or 50% of the radius of the cell or sector taking a base station managing the cell or sector as the center.

8. The method of claim 1, wherein the wireless communication system is a multi-carrier wireless communication system, and the primary carrier and the secondary cattier are sub-carriers in the multi-carrier wireless communication system.

9. The method of claim 8, further comprising:
using, by a full coverage type channel in the cell or sector, the primary sub-carrier.

10. The method of claim 8, further comprising:
bearing, by the primary sub-carrier in the cell or sector, signaling.

11. The method of claim 8, further comprising:
using, by a service channel in the cell or sector, the primary sub-carrier when a terminal is located in an area beyond a predetermining distance to the center of the cell or sector.

12. The method of claim 1, further comprising:
adjusting the ratio of the second transmit power threshold set for the secondary carrier to the first transmit power threshold set for the primary carrier dynamically.

13. The method of claim 12, wherein the adjusting the ratio dynamically comprises:
reducing the ratio of the second transmit power threshold to the first transmit power threshold if a proportion of traffic in an area beyond a predetermining distance to the center of the cell or sector to a total traffic of the cell or sector increases; and
increasing the ratio of the second transmit power threshold to the first transmit power threshold if the proportion of the traffic in the area beyond the predetermining distance to the center of the cell or sector to the total traffic of the cell or sector decreases.

14. An apparatus for implementing soft frequency reuse in a wireless communication system, comprising:
a serial-to-parallel converter, configured to converting a data entered in serial into multiple parallel data sub-streams and export the data sub-streams;
an inverse Fourier transformer, configured to perform inverse Fourier transform for the data sub-streams, and map the data sub-streams onto multiple carriers, respectively;
a parallel-to-serial converter, configured to convert the multiple carriers into one data stream and export the data stream;
an adjuster, configured to multiply the parallel data sub-streams exported by the serial-to-parallel converter by a power coefficient; the power coefficient is used for adjusting transmit power of each carrier is not higher than a transmit power threshold; and
a control device, configured to control the power coefficient is not higher than a threshold of the power coefficient.

15. The apparatus of claim 14, wherein at least one carrier is selected as a primary carrier and at least one carrier is selected as a secondary carrier;
the control device adjusts the ratio of a transmit power threshold set for the secondary carrier to a transmit power threshold set for the primary carrier dynamically.

16. The apparatus of claim 15, wherein the control device comprises:
a first unit, configured to reduce the ratio of the transmit power threshold set for the secondary carrier to the transmit power threshold set for the primary carrier if a proportion of traffic in an area beyond a predetermining distance to the center of a cell or sector to a total traffic of the cell or sector increases; and
a second unit, configured to increase the ratio of the transmit power threshold set for the secondary carrier to the transmit power threshold set for the primary carrier if the proportion of the traffic in the area beyond the predetermining distance to the center of the cell or sector to the total traffic of the cell or sector decreases.

17. A system for implementing soft frequency reuse in a wireless communication system, comprising:
a first unit, configured to select for a cell or sector at least one carrier as a primary carrier and at least one carrier as a secondary carrier, the primary carrier selected for the cell or sector and a primary carrier selected for another cell or sector adjacent to the cell or sector are non-overlapped; and
a second unit, configured to set a first transmit power threshold for the primary carrier and a second transmit power threshold for the secondary carrier, the first transmit power threshold is higher than the second transmit power threshold.

18. The system of claim 17, further comprising:
a first terminal in an area beyond a predetermining distance to the center of the cell or sector, configured to adapt the primary carrier;
a second terminal in an inner zone of the cell or sector configured to adapt the secondary carrier; the transmit power of the first terminal is not higher than the first transmit power threshold and the transmit power of the second terminal is not higher than the second transmit power threshold.
